(19) United States
(12) Patent Application Publication
(10) Pub. No.: US 2009/0253504 A1
(43) Pub. Date: Oct. 8, 2009

(54) Point managing device

(75) Inventors: Hisao Nishimoto, Tokyo (JP); Haruhisa Ujita, Tokyo (JP)

Correspondence Address: STAAS & HALSEY LLP, SUITE 700, 1201 NEW YORK AVENUE, N.W., WASHINGTON, DC, 20005, US

(73) Assignee: TOMY COMPANY, LTD., Tokyo (JP)

(21) Appl. No.: 12/285,872

(22) Filed: Oct. 15, 2008

(30) Foreign Application Priority Data
Apr. 8, 2008 (JP) 2008-100782

(51) Int. Cl. A63F 13/00

(52) U.S. Cl. 463/31

(57) ABSTRACT

A point managing device for increasing/decreasing the point possessed by a player based on the result of a competition in which toys actually compete against each other, and for encouraging games using the competing toys, is provided. A main body of the device is provided with a setting unit for setting a win/lose result, a memory unit for storing a cumulative total of points, a point information input/output unit for sending and receiving information on the points to and from a managing device of an opponent, and a control unit for determining a point(s) to be transferred based on the win/lose result. The control unit is configured so as to determine the transfer point based on the difference between the cumulative total of points of the opponent obtained via the point information input/output unit and that of one's own stored in the memory unit and the win/lose result set by the setting unit and update the cumulative total of points based on the determined transfer point.

### CROSS REFERENCE TO RELATED APPLICATION

This application claims the benefit under 35 U.S.C. Section 119 of Japanese Patent Application No. 2008-100782 filed Apr. 8, 2008, which is hereby incorporated by reference in its entirety into this application.

### BACKGROUND OF THE INVENTION

1. Field of the Invention

The present invention relates to a point managing device, particularly, a point managing device which reflects actual game results in a cumulative total of points by increasing/decreasing points based on the winning and losing of a game in which competing toy bodies actually compete against each other to determine the winner and the loser.

2. Description of the Related Art

Conventionally, various portable-type game devices which can each be played by only one person have been proposed and subjected to actual use; however, game devices which can carry out a game when two players operate respective operation input units have also been proposed (see, for example, Japanese Patent Application Laid-Open Publication No. 10-263212). The game devices are designed so that a game can be enjoyed by two players in which a character raised and trained by one of the players and a character raised and trained by the other or opponent compete against each other by operating operation buttons in accordance with game programs stored in built-in memories.

The above described game devices cause the game to progress based on the data generated in the game devices. That is, the game progresses based on the results of winning and losing consistently in a virtual world, not based on the results of actual toys competing against each other, thereby lacking the feeling of reality. In addition, even when a winner and a loser are determined by causing actual toy bodies to compete against each other, the winning/losing results merely remain in the memories of the users and there is no record every time. Therefore, competing of the toy bodies has not been capable of causing the users to strongly care whether they win or lose.

### SUMMARY OF THE INVENTION

The present invention has been accomplished in view of the foregoing problems. Accordingly, it is an object of the present invention to provide a new point managing device capable of increasing and decreasing the points possessed by players based on the results of actual competitions of competing toy bodies, thus encouraging the playing of games using the competing toy bodies.

There is provided a point managing device for managing points generated based on winning and losing of a game for determining the winning and losing by actually causing competing toy bodies to compete against each other. The point managing device includes: a main body; a setting unit for setting a win/lose result; a memory unit for storing a cumulative total of points; a point information input/output unit for sending and receiving information on the cumulative total of points to and from a managing device of a competing opponent; a control unit for determining a transfer point to be transferred based on the win/lose result, the setting unit, the memory unit, the point information input/output unit and the control unit being provided in the main body; the control unit being configured so as to determine the transfer point based on the difference between a cumulative total of points of the competing opponent obtained by the point information input/output unit and one's own cumulative total of points stored in the memory unit and based on the win/lose result set by the setting unit and update the cumulative total of points of the memory unit based on the transfer point; and a display unit provided in the main body for displaying the win/lose result set by the setting unit, the transfer point determined by the control unit, and the cumulative point updated based on the transfer point.

The control unit can be configured so that the transfer point to be transferred to the winner side is set to be inversely proportional to the amount of the cumulative total of points of the winner side with respect to the cumulative total of points of the loser side.

The memory unit may be provided with a counter for counting the number of competitions, and the control unit may be configured so as to calculate a remedial point based on the number of competitions counted by the counter when the cumulative total of points is equal to or less than zero and add the calculated remedial point to the cumulative total of points, thereby enabling continuous use even when the cumulative total of points becomes zero or less.

The memory unit may be provided with a point table storing an adjustment point set in accordance with the difference between the cumulative total of points of the competing opponent and one's own cumulative total of points stored in the memory unit, and the control unit may be configured so as to calculate the transfer point by adding the adjustment point to or subtracting the adjustment point from a basic point.

The setting unit include two operation buttons and switches respectively corresponding to the operation buttons so that either one of the two operation buttons sets a win result and the other button sets a lose result.

The point to be sent/received can be determined according to the cumulative total of points possessed by the opponent and one's own cumulative total of points merely by inputting the win or lose result, without requiring input of points from a keyboard, and thus enabling the user(s) to have little to do with the input process. Therefore, a point managing device capable of sending/receiving a fair amount of points and capable of carrying out point management by a simple operation can be provided.

According to one embodiment of the present invention, in the case where one's own cumulative total of points is larger than that of the competing opponent, merely a few transfer points are obtained even when the player wins and many transfer points are taken away when the player loses, and thus the new point managing device for reflecting the amount of one's own cumulative total of points to the transfer points without the transfer point of a constant amount being merely added thereto or subtracted therefrom according to the win or lose result can be realized.

According to one embodiment of the present invention, as a remedial measure in the case in which the cumulative total of points becomes zero or less, the number of past competitions is taken into consideration; therefore, it is expected that the user, on the assumption that the cumulative total of his own points may become zero, will intentionally increase the number of competitions. Such a point managing device in which the number of competitions is increased will lead to an increase in the use of competing toys such as toy tops.

### BRIEF DESCRIPTION OF THE DRAWINGS

FIGS. 1A and 1B are perspective views showing a point managing device according to one embodiment of the present invention and the state in which the managing device is attached to a spinner for a toy top, respectively;

FIG. 2 is a block diagram showing the managing device;

FIGS. 3A and 3B are an exploded view and an assembled view of a toy top which is one example of a competing toy body;

FIGS. 4A and 4B are a schematic plan view and a schematic front view showing the state in which competing toy bodies are caused to compete against each other;

FIG. 5 is a flowchart showing a manner of use of the managing device;

FIG. 6 is a flowchart showing a battle mode;

FIG. 7 is a flowchart showing an arithmetic process; and

FIG. 8 shows a point table for determining adjustment points.

### DESCRIPTION OF THE EMBODIMENTS

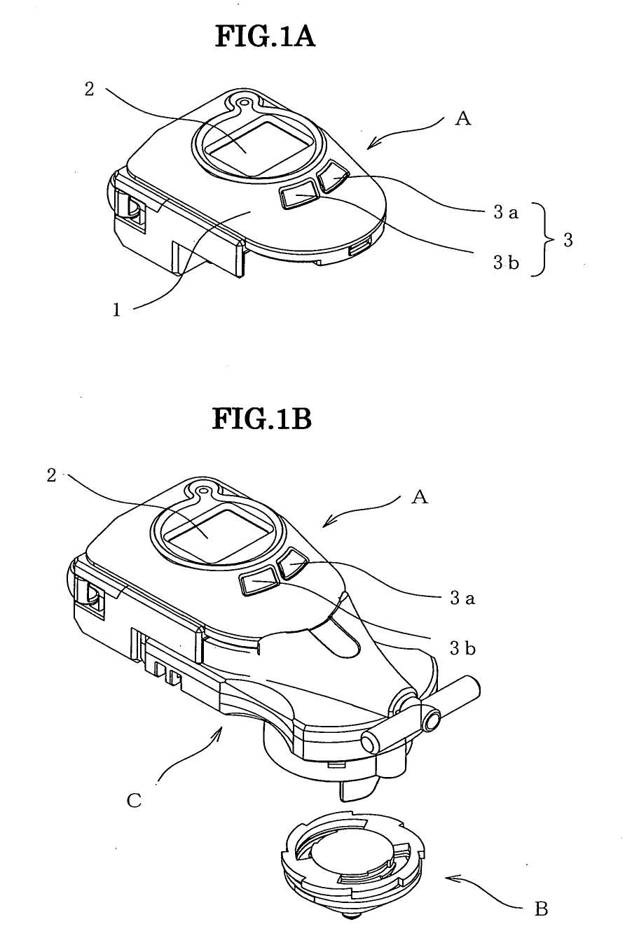

FIG. 1A is a perspective view of a point managing device A according to one embodiment of the present invention which manages points to increase or decrease them depending on competition results of competing toy bodies. The point managing device A (hereinafter, referred to as a managing device) is configured to reflect competition results of actual competitions between competing toy bodies to increase/decrease the points that the device possesses. A main body 1 of the device has such a size that it can be held in a palm and is formed to be portable. A display unit 2 which includes a liquid crystal display is disposed at the center of the main body 1. A setting unit 3 which includes two operation buttons, a first operation button 3a and a second operation button 3b pressed in accordance with the display displayed in the display unit 2, is disposed in the front of the display unit 2. A point information input/output unit (can be, a known unit, for example, an infrared-ray communication transceiver, a connecting terminal, a communication cable, or the like) which sends information on points to and receives it from another managing device is disposed on a rear surface of the main body 1.

In this embodiment, the competing toy body B of which points are managed by the managing device A is a toy top; therefore, the managing device A is configured so as to be attachable/detachable to or from a toy top spinner C which launches the competing toy body (hereinafter, referred to as a toy top) B (see FIG. 1B).

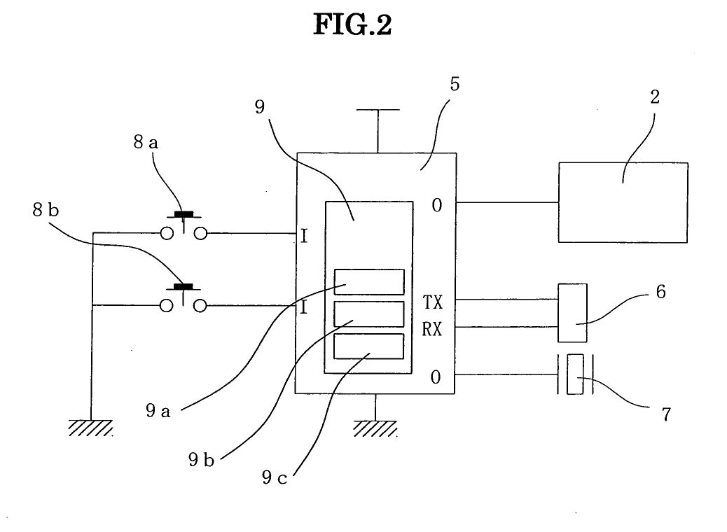

FIG. 2 is a block diagram of the managing device A including a CPU (control unit) 5 incorporating an LCD drive circuit, the liquid crystal display (display unit) 2, the point information input/output unit 6 for connection with a managing device of an opponent when point information is to be sent to or received from the competing opponent, a piezoelectric buzzer 7 which outputs sound effects, and switches 8a and 8b corresponding to the first operation button 3a and the second operation button 3b.

The CPU 5 is configured to control the entire managing device by a control program stored in an incorporated memory unit 9, and it is programmed so that successive processes of the program are carried out by determining the state of the switches 8a and 8b which are turned on/off in correspondence to the operation of the operation buttons 3a and 3b, thereby carrying out communication of data, display of information in the liquid crystal display 2, and output of sound effects from the piezoelectric buzzer 7.

The memory unit 9 is provided with a cumulative total memory 9a which stores the cumulative total of the points that are increased/decreased depending on competition results, a counter 9b which counts the number of competitions, and a point table 9c storing differences between one's own cumulative total of points and that of the competing opponent and adjustment points set based on the differences used for calculating transfer points, which will be described later.

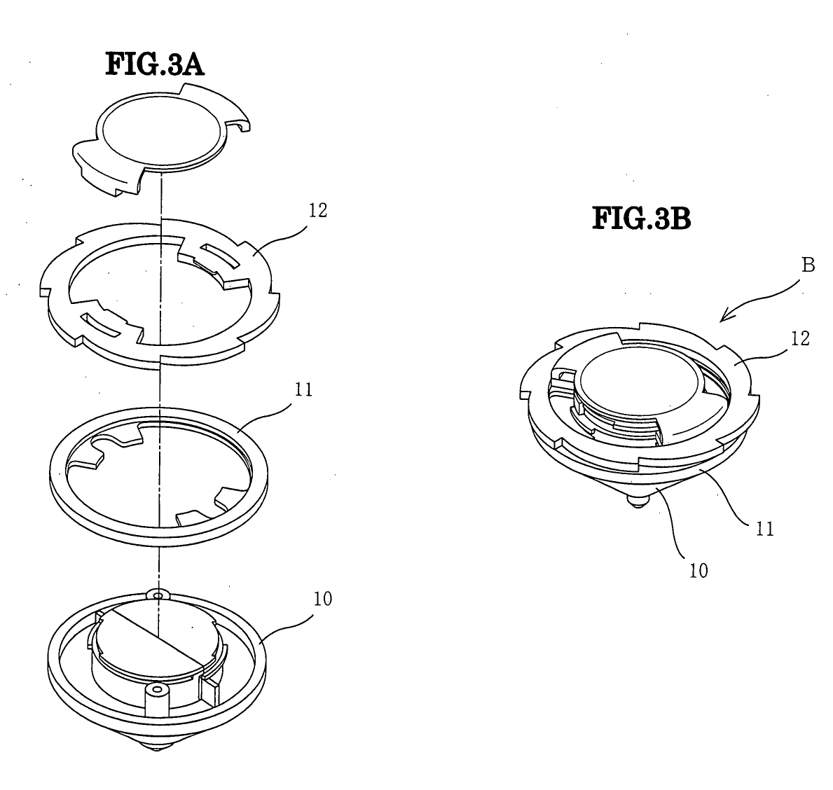

In the present embodiment, the toy top is applied as the competing toy body B as described above. BEYBLADE (registered trademark)is an example of a toy top available from Tomy Company LTD. of Tokyo Japan, the assignee of the present application, that can be used as the toy top. The toy top is formed as shown in FIG. 3B basically by combining three parts, a base 10, a weight disk 11, and an attack ring 12 as shown in FIG. 3A. Toy tops of different types such as an attack type, defense type, and endurance type can be selected and formed by users by combinations of the above described three parts 10, 11, and 12.

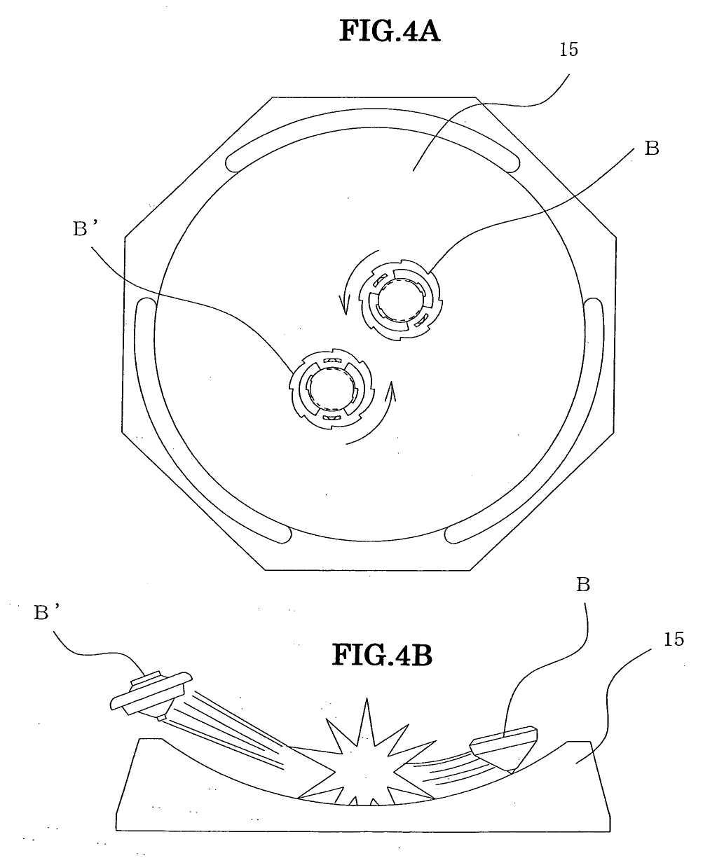

The toy tops are configured so that, when a toy top B of one's own and a toy top B′ of a competing opponent are caused to compete against each other on a competition stage 15 as shown in FIG. 4A, winning and losing is determined when either one of the toy tops (the toy top B′ in the drawing) is flicked out of the competition stage 15 as shown in FIG. 4B.

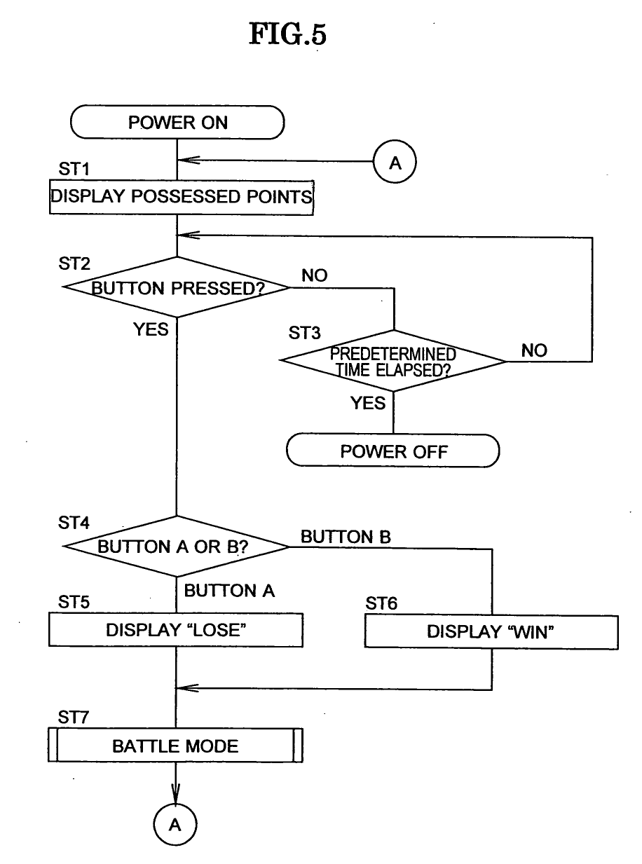

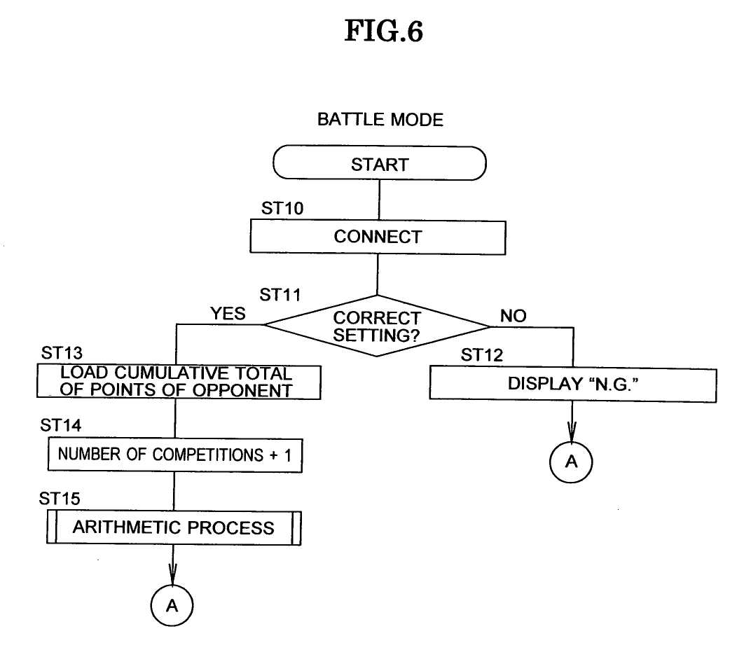

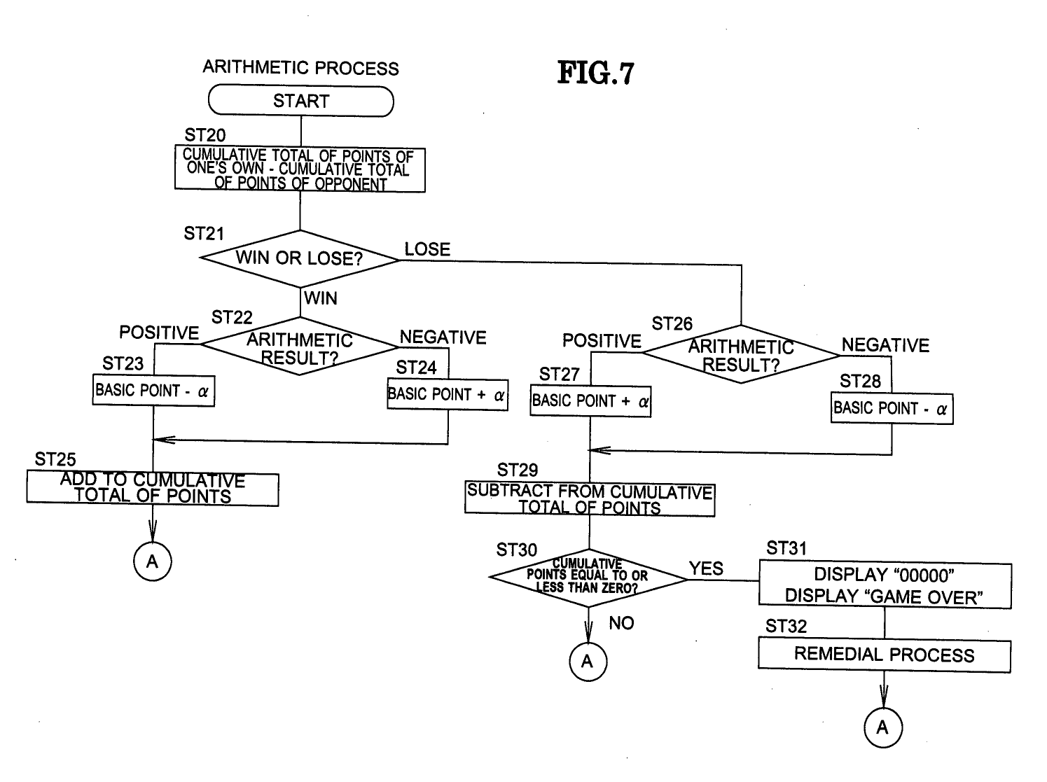

Next, a manner of using the above described managing device A will be explained based on flowchart diagrams of FIGS. 5 to 7.

After the toy top B actually finishes a competition on the competition stage 15, the competition result is manually input to the managing device A. First, when the operation button 3a (hereinafter, referred to as a button A) and the operation button 3b (hereinafter, referred to as a button B) are simultaneously pressed for a period of (for example, for three seconds), the power is turned on, and the control unit 5 displays the currently possessed points (cumulative total of points) stored in the cumulative total memory 9a (step ST1) and waits for the win/lose result to be set (step ST2). The win/lose result setting can be carried out by pressing the button 3a or 3b. In the present embodiment, these buttons are configured so that the button A is pressed when there is a lose result, and the button B is pressed when there is a win result.

When the state where the operation buttons 3a and 3b are not pressed is continued, and a predetermined time (in the present embodiment, set for five minutes) elapses (step ST3), the power is automatically turned off.

When the operation button 3a or 3b is pressed in step ST2, the process proceeds to step ST4 wherein the control unit 5 determines whether the pressed operation button is the button A or the button B. When the button A is pressed, it is determined that the competition is lost, and, after “LOSE” is displayed in the display unit 2 in step ST5, the process proceeds to step ST7 in which a battle mode begins. When the button B is pressed, it is determined that the competition is won, and, after “WIN” is displayed in the display unit 2 in step ST6, the process proceeds to step ST7 in which the battle mode begins.

In the battle mode, the managing device A is connected to a managing device of a competing opponent via the point information input/output unit 6 (step ST10). Whether the win result/lose result settings of both of the managing devices are correct or not (whether the setting of one's own and the setting of the opponent are the same or not) is determined (step ST11). When they are not correct settings (the setting of one's own and the setting of the opponent are the same), the process proceeds to step ST12 wherein “N.G.” is displayed in the display unit and returns to step ST1, and correct pressing of the operation button 3a or 3b is waited for.

When the settings are correct (the setting of one's own and the setting of the opponent are different) in step ST11, it is determined that the competition has been completed, the process proceeds to step ST13 in which the cumulative total of points of the opponent is loaded, and the counter 9b increases the number of competitions by one (step ST14).

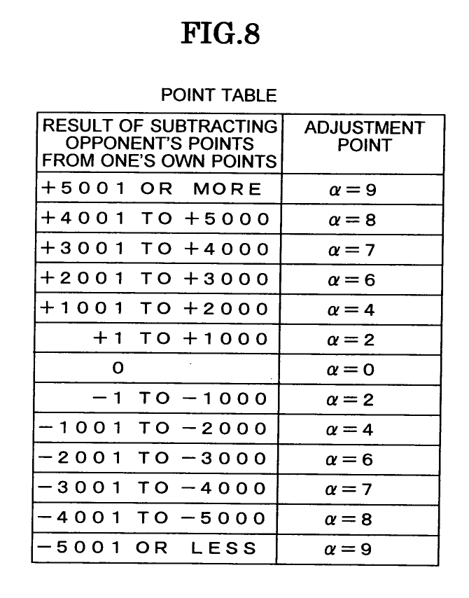

When the number of competitions is increased, the process proceeds to step ST15, and an arithmetic process is carried out. In the arithmetic process, in step ST20, the cumulative total of points of the opponent is subtracted from the cumulative total of points of one's own, and the difference therebetween is perceived. Then, the process proceeds to step ST21 in which whether the competition result is “win” or “lose” is determined. When it is “win”, the process proceeds to step ST22 in which whether the result of step ST 20 is a positive value or a negative value is determined. When the result is a positive value, the process proceeds to step ST23 in which transfer points are calculated by subtracting adjustment points α from basic points (in the present embodiment, set for 10 points); and, when it is a negative value, the process proceeds to step ST24 in which transfer points are calculated by adding the adjustment points α to the basic points. It should be noted that the adjustment points α are determined by referencing the point table 9c. The point table 9c stores, as shown in FIG. 8, the values of the adjustment points α which are set based on the differences between the cumulative total of points of one's own and the cumulative total of points of the competing opponent and are added to or subtracted from the basic points. The adjustment points a adjust the number of the transfer points to be transferred from the loser side to the winner side so that it is slightly advantageous to the one who has a smaller cumulative total of points.

For example, when the cumulative total of points of one's own are 4000 and the cumulative total of points of the opponent are 1500, the difference between the points is +2500; therefore, the transfer points are 4 points as a result of subtracting the adjustment points 6 from the basic points 10. When the cumulative total of points of one's own are 1500 and the cumulative total of points of the opponent are 4000, the difference between the points is −2500; therefore, the transfer points are 16 points as a result of adding the adjustment points 6 to the basic points 10.

Thus, it is programmed so that, even when the player wins a competition against the opponent, when the cumulative total of points of his own is more than that of the opponent, it is determined to be natural to have won, and the obtained points are thus reduced; when the cumulative total of points is less than that of the opponent, obtained points are increased as a reward for winning a competition against a strong opponent.

When the transfer points are determined, the process proceeds to step ST25 wherein an adding process is carried out. Then, the process returns to step ST1 wherein the updated new cumulative total of points is displayed in the display unit 2, and a pressing operation of the operation button 3a or 3b is waited for.

On the other hand, when “lose” is determined in step ST21, the process proceeds to step ST26 wherein whether the result of step ST20 is a positive value or a negative value is determined. When the result is a positive value, the process proceeds to step ST27 wherein transfer points are calculated by adding the adjustment points α to the basic points; and when it is a negative value, the process proceeds to step ST28 wherein transfer points are calculated by subtracting the adjustment points a from the basic points.

For example, when the cumulative total of points of one's own are 4000 and the cumulative total of points of the opponent are 1500, the difference between the points is +2500; therefore, the transfer points are 16 points as a result of adding the adjustment points 6 to the basic points 10. When the cumulative total of points of one's own are 1500 and the cumulative total of points of the opponent are 4000, the difference between the points are −2500; therefore, the transfer points are 4 points as a result of subtracting the adjustment points 6 from the basic points 10.

Thus, it is programmed so that, even when the player loses a competition to the opponent, when the cumulative total of points of his own is less than that of the opponent, it is considered to have been inevitable to lose, and the number of points taken is thus small; and, when the cumulative total of points is larger than that of the opponent, the number of points taken is thus increased so that the negative effect is severe as a penalty for losing a competition to a weak opponent.

When the transfer points are determined, the process proceeds to step ST29 wherein a subtracting process is carried out and proceeds to step ST30 wherein whether the cumulative total of points after the subtraction is equal to or less than zero is determined. If it is not equal to or less than zero, the process returns to step ST1 wherein the updated new cumulative total of points is displayed in the display unit 2, and a pressing operation of the operation button 3a or 3b is waited for.

If the cumulative total of points after the subtraction is equal to or less than zero, the process proceeds to step ST31 wherein “00000” and “GAME OVER” is displayed in the display unit 2 so as to blink for a predetermined time (for example, for five seconds), then proceeds to step ST32 wherein a remedial process is carried out. In the remedial process, the total of remedial points is calculated by adding additional points, which are determined by a predetermined ratio (for example, fifty percent) with respect to the numerical value of the counter 9b counting the number of past competitions, to basic remedial points (for example, 20 points) set in advance, the calculated total of remedial points is added to the cumulative total of points of the cumulative total memory 9a, and the process returns to step ST1 wherein the updated cumulative total of points is displayed in the display unit 2. For example, when the number of competitions is 100, 50 points, which are the additional points corresponding to the number of 100 competitions, are added to the basic remedial points, 20 points; therefore, the total of remedial points is 70 points.

As described above, the managing device A can be caused to recognize whether the competition result is “win” or “lose” when the competing toys B are caused to actually compete against each other by pressing either one of the two buttons, the button A or the button B. After a win/lose result is set, merely by mutually connecting the managing devices A, the winner can acquire the transfer points, and the loser releases the transfer points. Thus, the managing device capable of updating the cumulative total of points without complex operations and having excellent operability can be realized.

In addition, in the case where the player wishes to increase the cumulative total of points, it may be necessary to improve the competing ability of the competing toy B. To do so, it will be necessary to recombine constituent parts of the competing toys using his ingenuity, which will make the competing toys more interesting to the users. Further, such recombining may make it necessary for the user to purchase new constituent parts, which will be beneficial to manufacturers of the competing toys.

Moreover, the remedial measure is taken even when the players successively lose and the cumulative total of points disappears; and, since the remedial measure is reflected in the number of competitions, the players willingly repeat competitions, and thus the competition games with the competing toys can be encouraged.

It should be noted that it is preferable that predetermined points (for example, 1000 points) be registered in the cumulative total memory 9a in advance when the user purchases a point managing device from an outlet store, and such predetermined points can be registered by a maker of the point managing device in the cumulative total memory 9a in a manufacturing stage.

The above described competing toys are not limited to toy tops. Instead, these competing toys can be board games, for example, Japanese chess and Gomoku (five-in-a-row), running races by running toys, and the like as long as winning and losing can be determined by competition results, and the utilization range thereof is not limited.

1. A point managing device for managing points generated based on winning and losing of a game of competing toy bodies, comprising:
a main body;
a setting unit for setting a user's win/lose result;
a memory unit for storing a cumulative total of points;
a point information input/output unit for sending and receiving information on the cumulative total of points to and from a point managing device of a competing opponent;
a control unit for determining at least one transfer point to be transferred based on the win/lose result, the setting unit, the memory unit, the point information input/output unit and the control unit being provided on the main body;
the control unit determining the at least one transfer point based on a difference between a cumulative total of points of the competing opponent obtained by the point information input/output unit and the user's cumulative total of points stored in the memory unit and based on the win/lose result set by the setting unit and updating the cumulative total of points of the memory unit based on the at least one transfer point; and
a display unit provided on the main body for displaying the win/lose result set by the setting unit, the at least one transfer point determined by the control unit, and the cumulative points updated based on the at least one transfer point.

2. The point managing device according to claim 1, wherein the control unit is configured so that the at least one transfer point to be transferred to a winner's side is set to be inversely proportional to the amount of the cumulative total of points of the winner's side with respect to the cumulative total of points of a loser's side.

3. The point managing device according to claim 1, wherein the memory unit is provided with a counter for counting a number of competitions between the user and the opponent, and the control unit calculates a remedial point based on the number of competitions counted by the counter when the cumulative total of points is equal to or less than zero and adds the calculated remedial point to the cumulative total of points.

4. The point managing device according to claim 2, wherein the memory unit is provided with a counter for counting a number of competitions between the user and the opponent, and the control unit calculates a remedial point based on the number of competitions counted by the counter when the cumulative total of points is equal to or less than zero and adds the calculated remedial point to the cumulative total of points.

5. The point managing device according to claim 1, wherein the memory unit is provided with a point table storing adjustment points in accordance with the difference between the cumulative total of points of the competing opponent and the user's cumulative total of points stored in the memory unit, and the control unit calculates the at least one transfer point by adding one of the adjustment points to or subtracting one of the adjustment points from a predetermined basic point.

6. The point managing device according to claim 2, wherein the memory unit is provided with a point table storing adjustment points in accordance with the difference between the cumulative total of points of the competing opponent and the user's cumulative total of points stored in the memory unit, and the control unit calculates the at least one transfer point by adding one of the adjustment points to or subtracting one of the adjustment points from a predetermined basic point.

7. The point managing device according to claim 3, wherein the memory unit is provided with a point table storing adjustment points in accordance with the difference between the cumulative total of points of the competing opponent and the user's cumulative total of points stored in the memory unit, and the control unit calculates the at least one transfer point by adding one of the adjustment points to or subtracting one of the adjustment points from a predetermined basic point.

8. The point managing device according to claim 1, wherein the setting unit includes two operation buttons and switches respectively corresponding to the operation buttons so that either one of the two operation buttons sets a win result and the other button sets a lose result.

9. The point managing device according to claim 2, wherein the setting unit includes two operation buttons and switches respectively corresponding to the operation buttons so that either one of the two operation buttons sets a win result and the other button sets a lose result.

10. The point managing device according to claim 3, wherein the setting unit includes two operation buttons and switches respectively corresponding to the operation buttons so that either one of the two operation buttons sets a win result and the other button sets a lose result.

11. The point managing device according to claim 5, wherein the setting unit includes two operation buttons and switches respectively corresponding to the operation buttons so that either one of the two operation buttons sets a win result and the other button sets a lose result.

12. The point managing device according to claim 7, wherein the setting unit includes two operation buttons and switches respectively corresponding to the operation buttons so that either one of the two operation buttons sets a win result and the other button sets a lose result.

13. A scoring device, comprising:
first and second point managing devices, each having—
a main body;
a setting unit for setting a win/lose result;
a memory unit for storing a cumulative total of points;
a point information input/output unit for sending and receiving information on the cumulative total of points between the first and second point managing devices;
a control unit for determining at least one transfer point to be transferred based on the win/lose result;
wherein the control unit determines the at least one transfer point based on a difference between a cumulative total of points of the second point managing device obtained by the point information input/output unit and the cumulative total of points stored in the memory unit of the first point managing device, and based on the win/lose result set by the setting unit, updates the cumulative total of points of the memory unit based on the at least one transfer point; and
a display unit provided on the main body for displaying the win/lose result set by the setting unit, the at least one transfer point determined by the control unit, and the cumulative points updated based on the at least one transfer point.

14. The point managing device according to claim 13, wherein the at least one transfer point to be transferred to a winner's side is set to be inversely proportional to the amount of the cumulative total of points of the winner's side with respect to the cumulative total of points of a loser's side.

15. The point managing device according to claim 13, wherein the memory unit is provided with a counter for counting a number of competitions between opponents, and the control unit calculates a remedial point based on the number of competitions counted by the counter when the cumulative total of points is equal to or less than zero, and adds the calculated remedial point to the cumulative total of points.

16. The point managing device according to claim 13, wherein the memory unit is provided with a point table for storing adjustment points in accordance with the difference between the cumulative total of points of the opponents stored in the memory unit, and the control unit calculates the at least one transfer point by adding one of the adjustment points to or subtracting one of the adjustment points from a predetermined basic point.

17. The point managing device according to claim 13, wherein the setting unit includes two operation buttons and switches respectively corresponding to the operation buttons so that either one of the two operation buttons sets a win result and the other button sets a lose result.

18. A point managing device, comprising:
a main body;
a setting unit for setting a user's win/lose result;
a memory unit for storing a cumulative total of points;
a point information input/output unit for sending and receiving information on the cumulative total of points to and from a point managing device of a competing opponent;
a control unit for determining at least one transfer point to be transferred based on the win/lose result, the setting unit, the memory unit, the point information input/output unit and the control unit being provided on the main body;
the control unit determining the at least one transfer point based on a difference between a cumulative total of points of the competing opponent obtained by the point information input/output unit and the user's cumulative total of points stored in the memory unit and based on the win/lose result set by the setting unit and updating the cumulative total of points of the memory unit based on the at least one transfer point; and
a display unit provided in the main body for displaying the win/lose result set by the setting unit, the at least one transfer point determined by the control unit, and the cumulative points updated based on the at least one transfer point.
wherein the control unit is configured so that the at least one transfer point to be transferred to a winner's side is set to be inversely proportional to the amount of the cumulative total of points of the winner's side with respect to the cumulative total of points of a loser's side, and
wherein the memory unit is provided with a counter for counting a number of competitions between the user and the opponent, and the control unit calculates a remedial point based on the number of competitions counted by the counter, when the cumulative total of points is equal to or less than zero and adds the calculated remedial point to the cumulative total of points.

19. The point managing device according to claim 18, wherein the memory unit is provided with a point table storing adjustment points in accordance with the difference between the cumulative total of points of the competing opponent and the user's cumulative total of points stored in the memory unit, and the control unit calculates the at least one transfer point by adding one of the adjustment points to or subtracting one of the adjustment points from a predetermined basic point.

20. The point managing device according to claim 18, wherein the memory unit is provided with a point table storing adjustment points in accordance with the difference between the cumulative total of points of the competing opponent and the user's cumulative total of points stored in the memory unit, and the control unit calculates the at least one transfer point by adding one of the adjustment points to or subtracting one of the adjustment points from a predetermined basic point.
